(19) United States
(12) Patent Application Publication
(10) Pub. No.: US 2023/0196488 A1
(43) Pub. Date: Jun. 22, 2023

(54) REAL ESTATE WORKFLOW WITH VERIFIED IDENTIFICATION

(71) Applicant: OWNLY LIMITED, Calgary (CA)

(72) Inventors: Jason HARDY, Calgary (CA); Ray YIP, Calgary (CA)

(21) Appl. No.: 18/082,949

(22) Filed: Dec. 16, 2022

Related U.S. Application Data
(60) Provisional application No. 63/290,283, filed on Dec. 16, 2021.

(51) Int. Cl. G06Q 50/18; G06Q 50/16; G06Q 20/38; G06Q 40/03

(52) U.S. Cl. CPC G06Q 50/188; G06Q 50/16; G06Q 20/382; G06Q 40/03

(57) ABSTRACT

A method for facilitating a real estate transaction includes sending an authentication request of a buyer to an identity authentication service. Receiving, from the authentication server, a verified identification (ID) of the buyer. Sending a financing request of the buyer to a financing server. Receiving, from the financing server, an approved limit of the verified ID. Sending an offer to a seller where the offer includes the verified ID, the approved limit, and a property, configuration of the buyer. Also, receiving, from the seller, a response to the offer where the response is based on the verified ID and the financing request.

### CROSS-REFERENCE TO RELATED APPLICATIONS

This application claims the benefit of priority to U.S. provisional patent application Ser. No. 63/290,283 entitled “REAL ESTATE WORKFLOW WITH VERIFIED IDENTIFICATION” filed Dec. 16, 2021, hereby incorporated by reference in its entirety.

### FIELD OF THE INVENTION

The present invention pertains to online real estate transactions, and in particular to the use of a buyer's verified information to facilitate transactions with multiple involved parties.

### BACKGROUND

The real estate industry is well established and the traditional process of purchasing a real estate property is well established. The process involved a buyer and seller, but also agents, brokers, bankers, lawyers, and other parties. Despite the use of online websites and services offered by real estate brokers, sellers, marketplaces and financial institutions, the process is time and labor intensive with many in person meetings, verifications and signings required. Due to the nature of the transaction and the high price of housing, the identity of a buyer and their available funds must be authenticated or verified at multiple times during the process before the buyer may take ownership of the property. The requirements to authenticate a buyer as well as to verify the buyer's financial situation leads to delays and complicates the digitization of the process.

When the seller is a new home builder or developer, the process is further complicated in that there are many configuration options, such as upgrades, that a buyer may choose from to customize their new home. The configuration of the property can affect not just the pricing, but also the completion date of the property.

Therefore, there is a need for a method and apparatus that provides for the authentication of a buyer and verification of their financing that may be integrated into a property purchase workflow that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiment of the present invention is to provide methods and apparatus that utilize a verified identification (ID) of a buyer to authenticate the buyer to the different parties of the real estate transaction. The verified LD is associate with verified financing. The verified ID, the verified financing, or both the verified ID and verified financing may be securely shared with parties of the real estate transaction to allow for the verification of a buyer's identification and approved financing throughout the stages of the transaction.

Embodiments may be used when the seller is a house builder or developer constructing custom and semi-custom houses, condominiums, apartments, etc. that may be customized or upgraded prior to or during construction.

Embodiments allow for a buyer to verify their identity, obtain proof of financing, and select properties based on location, environment, size, feature, upgrades, and price while minimizing interactions with a selling home builder or developer, broker, agent, or leasing agent. Offers may be made, deposits and payments made, and legal aspects of closing a purchase may also be done in an automated and virtual fashion with limited or no face-to-face meetings.

In accordance with embodiments of the present invention, there is provided a method for facilitating a real estate transaction. The method includes sending an authentication request of a buyer to an identity authentication service and receiving, from the authentication server, a verified identification (ID) of the buyer. Also, sending a financing request of the buyer to a financing server and receiving, from the financing server, an approved limit of the verified ID. Then, sending an offer to a seller, the offer including the verified ID, the approved limit, and a property configuration of the buyer and receiving, from the seller, a response to the offer, where the response is based on the verified ID and the financing request.

In further embodiments, the property configuration is received from a server of the seller in response to the buyer selecting a plurality of preferences of a property described by the property configuration.

In further embodiments, the property configuration includes a location and a feature of the property.

In further embodiments, the approved limit includes one of a pre-approved mortgage limit, a deposit, or an approved mortgage.

Embodiments further include transferring a deposit from the buyer to the seller or broker based on the verified ID and the approved limit.

In further embodiments, the response to the offer includes an acceptance of the offer, and the method further includes signing the offer, by the buyer and the seller or buyer and listing broker, utilizing the verified ID and the approved limit.

Further embodiments include transferring a purchase amount from the buyer to the seller based on the verified ID and the approved limit.

Further embodiments include transferring an ownership of a property of the offer, the ownership being transferred to the buyer, the buyer being verified by the verified ID.

In accordance with embodiments of the present invention, there is provided a method of purchasing a property. The method includes creating a profile of a user on a server of a service provider. Then, initiating with the service provider, an authentication request and uploading an identification document to the server to verifying an identity of the user, thereby creating a verified identification (ID) of the user, where the verified ID is stored on the server. Also, initiating a financing request and obtaining an approved limit associated with the verified ID, where the approved limit is stored on the server. Furthermore, initiating with the service provider, an offer on the property, the offer including the verified ID, the approved limit, and a property configuration of the property, and receiving from the service provider, an approval of the offer.

In accordance with embodiments of the present invention, there is provided a method of selling a property. The method includes creating a profile of a property on a server of a service provider. Then, receiving from the service provider, an offer for the property, where the offer includes a verified identification (ID) of a buyer and an approved limit of the buyer. Also, generating a response to the offer based on the verified ID and the approved limit, and sending the response to the service provider.

In embodiments, the profile includes one of a location of the property, a configuration option of the property, or a price of the property.

Further embodiments include receiving a deposit of the buyer.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides an illustration of an environment for the purchase of a property from a home builder or developer or broker, according to an embodiment.

FIG. 2 provides a flow chart for methods of buying a property, according to an embodiment.

FIG. 3 provides a flow chart for methods of selling a property, according to an embodiment.

FIGS. 4A and 4B provide signal flow diagrams of methods used to buy and sell properties, according to an embodiment.

FIG. 5 provides a block diagram of a computing device which may be used to implement the methods as described herein.

It will be noted that throughout the appended drawings, like features are identified by like reference numerals.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Embodiments of the present invention provide methods that utilize a verified identification (ID) of a buyer to authenticate the buyer to the different parties of a real estate transaction. The verified ID is associate with verified financing. The verified ID, the verified financing, or both the verified ID and verified financing may be securely shared with parties of the real estate transaction to allow for the verification of a buyer's identification and approved financing throughout the stages of the transaction.

Embodiments may be used when the seller is a house builder or developer constructing custom and semi-custom houses, condominiums, apartments, single dwelling units or homes, multi-family homes, etc. that may be customized or upgraded during construction. Furthermore, a seller may include a broker, agent, leasing agent, listing broker, or any party representing the interests of a house builder or developer.

Embodiments may be used for the purchase of any and all forms of real estate inclusive of “resale” homes, new homes, and homes for purchase, lease, or rent.

Embodiments allow for a buyer to verify their identity, obtain proof of financing, and select properties based on location, environment, size, feature, upgrades, and price while minimizing interactions with a selling home builder, developer, or broker. Offers may be made, deposits and payments made, and legal aspects of closing a purchase may also be done in an automated and virtual fashion with limited or no face-to-face meetings. Proof of financing may be used by involved parties to facilitate the verification of pre-approved, approved, verified, or confirmed financing for deposits, purchase price, fees, etc.

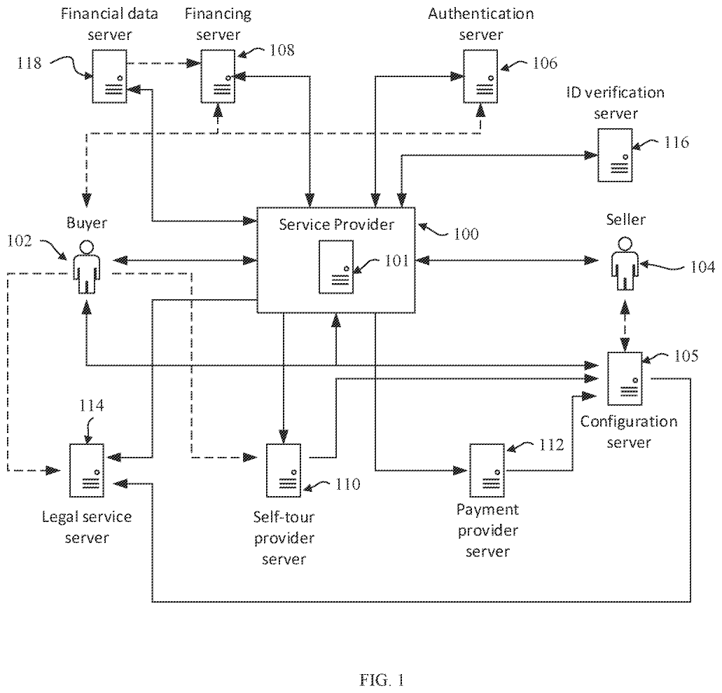

FIG. 1 illustrates provides an illustration of an environment for the purchase of a property from a home builder, developer, or broker according to an embodiment. A service provider 100 supplies a computing platform to implement the methods required to buy and sell a real estate property. The computing platform includes one or more computing devices that may be computer servers 101 to provide computing, storage, and network resources. Service provider 100 may be accessed over a computer network such as the Internet that allows buyers 102, sellers 104, and other service providers access to the computing platform. Data, such as files, may be sent and received over the network and may be encrypted, compressed, encoded, or otherwise processed to ensure reliable and secure communications.

Buyer 102 is a party interested in buying real estate which may include a home, townhouse, apartment, condominium, etc. Buyer 102 may be a single or multiple people, a company, a representative or agent of a person, persons or company, or any other entity legally able to purchase real estate. Buyer 102 may use any type of computing device such as a mobile device; a cell phone, tablet, etc., laptop, computer, etc. to access the service provider 100 and other service providers in the platform. In embodiments, buyer 102 may be multiple buyers or co-buyers. A buyer may invite a co-buyers into a “buying party” and go through the verify process so that each co-buyer may obtain a verified ID and verified financial status separately. The combined verified ID and financials of a buying party may improve the buying power (e.g., purchase amount) of the buying party. Co-buyer information can also be included in the buying process as well as legal document signing.

Seller 104 may be any type of real estate seller and in embodiments, may be a new house builder, developer, broker, etc. Seller 104 may be building and selling multiple properties of different sizes, shapes, configurations, etc. in multiple locations within one or more geographies areas, and including new homes as well as resale homes. Seller 104 may access the platform using computing devices and may be the owner of, or be associated with a configuration server 105. Configuration server 105 stores and provides access to the properties of the seller 104 that are available for sale. Configuration server 105 may run database software to manage and provide information, including descriptions, specifications, image, videos, configuration options and upgrades for the seller's properties. In embodiment, seller 104 may also include or be associated with real estate agents, online listing platforms such as MLS, Realtor.com, and other for-sales-by-owners listing platforms.

Authentication server 106 is a service provide that provides the ability to verify the identity of buyer 102 based on information provided by the buyer 102 such as government issued identification. Information is provided to the authentication server 106 by the buyer 102, which may be provided directly by the buyer 102 or through the service provider 100, and the authentication server 106 returns an authentication response attesting to the buyer's 102 identity. The authentication response becomes a Verified Identification (verified ID) which is stored by the service provider and is used by any of the other service providers to complete some or all of the property buying process described herein.

Financing server 108 is a service provider that is used to obtain financing pre-approval or approval for the purchase of a property by the buyer 102. This may include pre-approval of a mortgage, approval of a mortgage, proof of funds, credit approval, or other financial approval wherein a buyer 104 and other involved parties may obtain confirmation of an approved financing limit.

Self tour provider 110 is a service provider that may be a separate organization, or be part of service provider 100 or seller 104 and may provide virtual or physical tours of a property that the buyer 102 is interested in. Bookings may be made by the buyer 102 or through the service provider 100. In the case of virtual tours, information from the configuration server 105 may be used to generate a virtual environment or the interior and exterior of a property of interest to allow the buyer 102 to view the property, including any or all options selected. In the case of physical tour, a tour schedule may be sent from the self tour provider 110 to the seller 104 in order to schedule the tour.

Payment provider server 112 is a service provider used for the transfer of kinds from the buyer 102 to the seller 104 and from either the buyer 102 or seller 104 to any of the other service providers of the computing platform. The payment provider may comply with any or all money laundering rules, FINTRAC, or know your customer (KYC) regulations in the jurisdictions of the buyer 102, the seller 104, or both the buyer 102 and the seller 104.

Legal services provider 114 is a service provider and may be a real estate law firm, notary, or other party qualified to close the purchase of a property by buyer 102 from seller 104 and the transfer of ownership, payment of taxes, and any other requirements of the transaction.

ID verification server 116 is a service provider that may be used for verifying ID (for KYC requirements) through government issued documents like a driver's license or passport.

Financial data server 118 is a service provider that may allow users to connect to the buyer's 102 bank account for analyzing and verifying income and expenses. It may also provide information for KYC requirements and a buyer's employer if available.

In embodiments, any or all or service providers authentication server 106, financing server 108, self tour provider 110, payment provider server 112, or legal services provider 114 may be part of service provider 100 or may be one or more separate entities. A single separate entity may provide one or more of these services or each service may be provided by a separate entity.

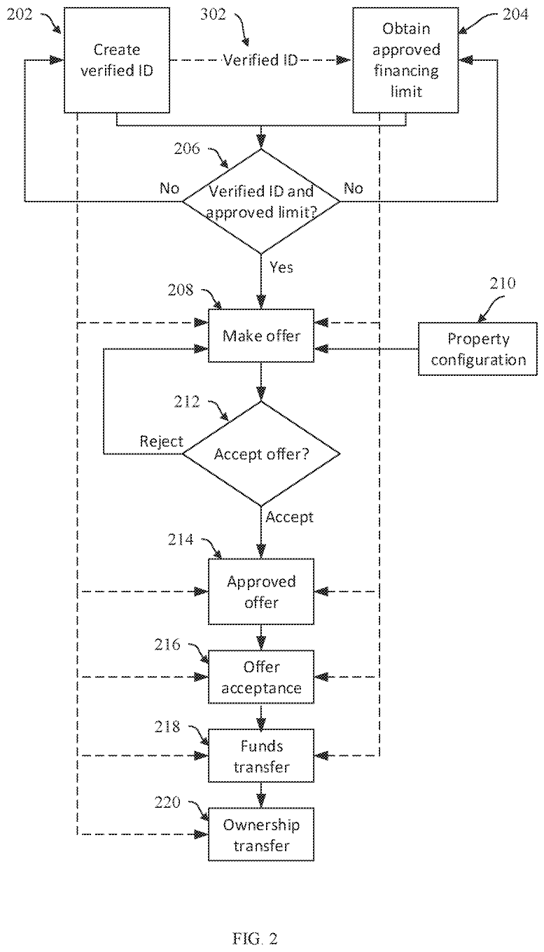

FIG. 2 provides a flow chart for methods for a buyer 102 to purchase a property, according to an embodiment. Embodiments include the use of a verified ID to enable any parties involved in a real estate transaction to be certain of a buyer's identity. Therefore, an initial step is to determine if the buyer has had their identity validated and, if not, create a verified ID in step. 202. Verification may be done by the platform service provider 100 and may utilize an authentication server 106 provided by the service provider 100 or by a third-party organization. Once verified, a buyer 102 (or other user of the platform) may utilize a “customer user account” and sign onto their account using industry standard authentication methods such as logging in with an Apple ID, Google account, Facebook account, etc. Once authenticated, the buyer 102 or other user will be able to securely interact and share permission-based profile information with trusted parties like home builders, realtors, brokers, etc. In step 204, if the buyer does not already have financing, the buyer may apply to obtain a financing limit on the purchase of a property, which may be a pre-approved mortgage or proof of funds. Financing may be obtained from or through the platform service provider 100 and may utilize a financing server 108 provided by the service provider 100 or by a third-party financial organization such as a bank or other lender. Proof that a buyer 102 has obtained financing may be communicated electronically or the buyer 102 or lender may upload documents to the service provider 100. Verification of financing may also include information related to integrated bank data connections, or other electronic data. In embodiments, in step 206, both a verified. ID and an approved financing limit may be required before a buyer is allowed to proceed with the process of making an offer in step 208. Verification of financing may also include a valuation of a buyer's current residence which can involve internal or external algorithms to monitor and calculate current home values. Once a buyer's identity has been verified, their present resident address or other owned property can be determined or verified. Owned property may be determined or verified as part of KYC information, land registries, or other ownership records or databases.

Prior to making an offer 208, a buyer may access electronic or physical information of one or more sellers 104, and a configuration server 105 of a seller 104 or configuration servers 105 associated with one or more seller's 104. A buyer 102 may look for real estate in a number of locations of interest and conduct searches based on criteria including location, type of dwelling, number of floors, number of rooms of various types, size, layout of rooms, or other criteria. A buyer may also conduct virtual or physical walk-throughs or tours of properties of interest. In the case that a property is not yet built, is presently being built, or may be customized, any number of customization options or upgrade options may be selected.

In step 208, a buyer 102 may make an offer on a property. An offer may take into account or be based on several factors including a possession or occupation date, time of or time remaining in a bidding or building process, a number of offers on the property, a minimum or maximum offer which may be a static or dynamic value, a difference between the buyer's 102 financing limit and the amount being offered, any terms and conditions, etc. Offers may also include property configuration 210 information as described above. The offer is accompanied with the verified ID to attest to the buyer's 102 identity and the approved financing limit ensuring that the buyer 102 has financial resources equal or greater than the offer price.

In embodiments, offers, responses, and other communications may be done by electronic messages such as email, messaging (such as SMS, text message, iMessage, Messenger, WhatsApp), etc. Messages may be accompanied by notifications that an offer has been submitted, received, or reviewed, as well as further informational messages such as a status or progress of a transaction. Messages may also include electronic links, such as hyperlinks or URLs, to allow a buyer 102 or seller 104 to easily navigate to a website or page for further information.

In step 212 the seller 104 may review an offer and decide to reject or accept the offer. If the seller 104 rejects the offer, the buyer 102 may be informed by a message such as an email, text message, etc. informing them that the offer has been rejected and may also include electronic links to other available properties that meet the buyer's criteria. A seller 104 may provide a counteroffer which may be communicated to the buyer 102 via electronic messaging and include information on the counteroffer which may include electronic links to allow the buyer 102 to easily respond to the counteroffer. In step 214, the seller 104 accepts the buyer's 102 offer, the buyer 102 may be informed via electronic messaging that may include a link to allow the buyer 102 to electronically sign the offer. The verified ID of the buyer 102 may be used to attest to the identity of the buyer 102.

In step 216 an offer is accepted by both the buyer 102 and the seller 104, with the identity of the buyer 102 attested by their verified ID. In embodiment, a buyer 104 may also have a verified ID. The acceptance of the offer is confirmed via electronic messaging.

The acceptance of an offer in step 214 may also require a deposit to be paid by the buyer 102 to the seller 104. In step 218, a deposit may be made via electronic funds transfer (EFT), e-Transfer, direct deposit, or similar funds transfer and may be done with the aid of payment provider 112. The payment provider 112 may be provided with the verified ID of the buyer 102 and/or the seller 104, and may use the verified ID to verify the identification of the buyer 102 or seller 104.

In step 220, the transfer of ownership of the property may be performed through the use of legal service 114. A verified ID of either or both of the buyer 102 or the seller 104 may be used to facilitate the transaction. The transfer of ownership can be a complex legal and conveyancing process that may include title transfer, insurance processes, and the transfer of a final payment from the mortgage lender, on behalf of the buyer 102, to the seller 104.

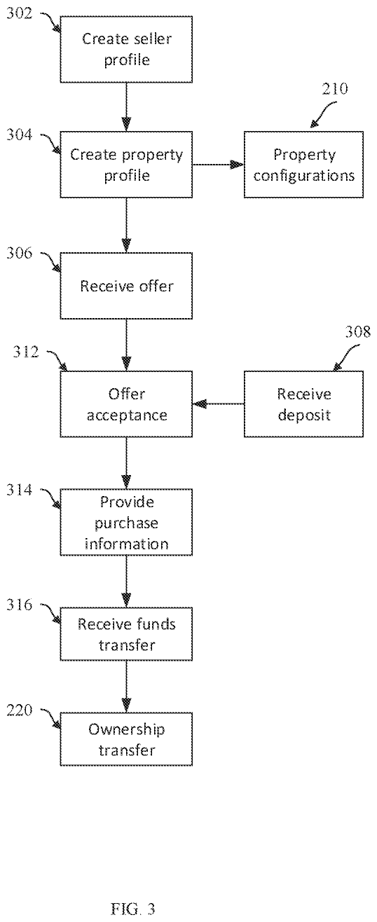

FIG. 3 provides a flow chart for methods for a seller 104 to sell a property, according to an embodiment. A property seller may be a home builder or developer, broker, a private seller, or any other party selling a property, home, apartment, condominium, etc. In step 302, a seller 104 may create a profile with the service provider 100 that may include the creation of a verified BD as in the case of the buyer in step 202 of FIG. 2. In step 304 seller 104 may create profiles for each of their properties. Profiles may include any number of criteria or characteristics such as location, type of dwelling, number of floors, number of rooms of various types, size, or layout of rooms. A profile may also include audio-visual information to create or generate virtual walk-throughs of the properties. In the case that a property is not yet built, is presently being built, or may be customized, a profile may also include any number of property customization 210 options or upgrade options that may be selected by a buyer 102.

In step 306, the seller 104 may receive an offer from a buyer 102 which may be accepted, rejected, or the seller 104 may make a counteroffer. In step 312, if the offer has been accepted, and in step 308 the seller 104 may receive a deposit from payment provider 112. In some cases, such as the case of a moved-in-ready or quick-possession home, the seller 104 may simply need a deposit to proceed to a purchase agreement stage. In step 314, the seller may provider further purchase information such as construction and possession dates. In 316, on closing of the transaction, remaining funds may be received from the buyer 102 through the payment provider 112. In step 220, the ownership transfer may take place, facilitated by legal service 114. Throughout the steps and transactions of FIG. 3, a verified ID and approved financing limit of the buyer 102 may be received from service provider 100 in order to attest to the buyer's 100 identity and their available financing in order to aid the seller 104 and other service providers in processing transactions as described in FIG. 3. In embodiments, a verified ID of the seller and other parties may be used to also facilitate transactions.

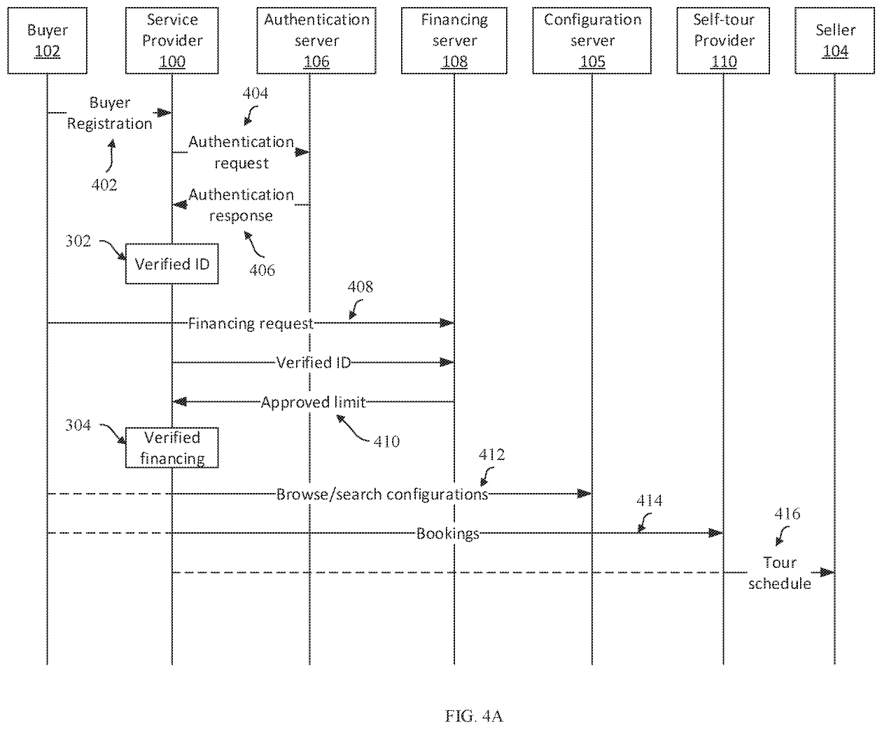

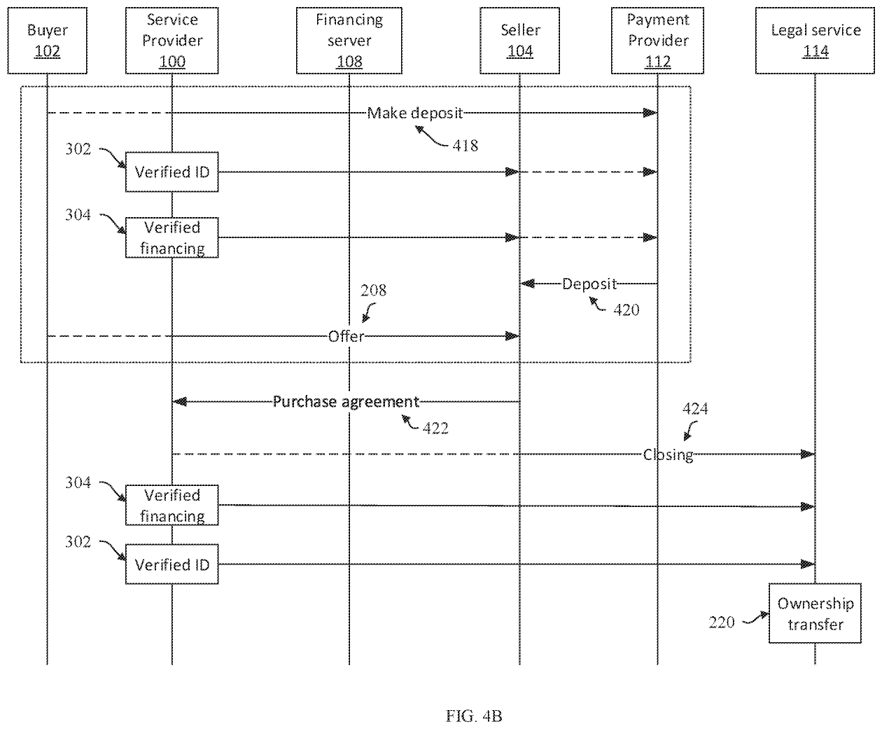

FIGS. 4A and 4B provide signal flow diagrams of methods used to buy and sell properties, according to an embodiment. With reference to FIG. 4A, a buyer 102 may send a registration request 402 to register with service provider 100. Registration request 402 may include a reference ID including information such as the buyer's 102 name, email, and phone number. In embodiments, any party, such as seller 104, that uses the system as a buyer 102, seller 104, or service provider may register with the service provider 100. Once a buyer 102 has registered, service provider 100 sends an authentication request 404 to an authentication server 106. The authentication request 404 may include information from the registration request 402 that may include the name, email, and email of the buyer 102. The authentication server 106 performs an authentication process that may require the buyer 102 to provide further information that may include one or more digital images of government issued identification, etc. On successful authentication of buyer 102, the authentication server 106 returns an authentication response 406 to the service provider 100. The authentication response 406 may include buyer information including full legal name, date of birth, home or work address, and a list of documents that may include for each document a document ID, an issuer, and an expiry date. Once the authentication response 406 is received by the service provider 100, the service provider 100 saves the information as a verified ID 302 for the buyer 102.

In embodiments, the service provider 100 stores the decrypted verified ID 302 in a secure Personally identifiable information (PII) database which is isolated from the outside network and can only be accessed by private microservices of the service provider 100. The verified ID 302 may be securely exchanged with other service providers in the system by exchanging a client ID, a signature verification key, an encryption key, and reference ID, and a callback URL. The client ID is used to identify the party or entity involved and each integrated party or service provider using the platform will register a mutual client ID with the platform. The signature verification key may be an OAuth 2.0 bearer token that may be a self-issued JSON Web Token (JWT). The JWT must be digitally signed with the signing key of the party. Encryption may be used to encrypt and decrypt the verified ID 302 data before and after transmission. The callback URL is an API endpoint URI, to notify the integrated party, entity, or service provider that a verified ID 302 is waiting for retrieval with reference ID. The reference ID may be used to identify the requested or requesting user.

In an embodiment, authorization of a buyer 102 may start with a service provider 100 initializing a request to the authentication server 106 to start a new identity verification by sending an authentication request 404 including a reference ID of the buyer 102 and a signed OAuth bearer token and callback URL to the authentication server 106. Upon authenticating the authentication request 404, the authentication server 106 may return a unique link in the form of a QR code, a URL (via text message), etc. for the buyer 102 to scan or access and begin the authentication process. The authentication server 106 captures and verifies an ID card with the buyer 102 performing a selfie video. Once the verification is complete, the authentication server 106 will return an authentication response 406 that includes the transaction ID to the service provider's 100 callback URL endpoint. In most cases, the authentication will take some time to complete and the service provider 100 will retrieve a status of a pending authentication transaction until either it completes or times out. The service provider 100 may retrieves the verified ID 302 information from the authentication server 106 using the transaction ID. The authentication server 106 returns identification card data which is a signed and encrypted JWT containing the personally identifiable information from the ID card. The payload of the decrypted JWT includes a Protected Card Data. It also returns a card image which is a signed and encrypted JWT containing the base64 encoded image data for the front of the ID card. The payload of the decrypted JWT is a Protected Image Data.

In embodiments, three methods of obtaining financial verification (purchase limit and loan amounts) may be used. One method may include connecting to a buyer's online bank account to verify total income (employer income, government income, etc.) and expenses (bill payments, loan payments, etc.) and determining a home buying limit (or home affordability amount). A second method may include allowing buyers to upload a pre-approval document obtained from a bank, broker, or lender, allowing the system to validate and confirm the loan amount and purchase limit. A third method includes Obtaining financing pre-approval as described herein.

A buyer 102 must also have their financing pre-approved, approved, or verified. Buyer 102 sends a financing request 408 to an authentication server 106. The financing request 408 may include the verified ID 302 of the buyer 102 and may also include further information provided directly by the buyer 102. A financing limit is approved and an approved limit 410 is sent back to the service provider 102. The financing limit may be a mortgage preapproval and include information such as the buyer's full legal name, information on the lender, a mortgage or application ID, an approved purchase amount, an approval expiry date, etc. Once the approval limit 410 is received by the service provider 100, the service provider 100 saves the information as verified financing 304 for the buyer 102. Financial verification may include credit score information where a consumer credit score of the buyer 102 or co-buyers may be retrieved through a partner platform. The credit score may be from organizations such as Equifax, Transunion, or Experian. As an alternative to exact credit scores, the seller may only receive a range or scale of the buyer's score such as Excellent, Good, Average, or Poor in order to conform to any relevant privacy regulatory requirements.

In embodiments, the service provider 100 stores the decrypted verified financing 304 data in a secure PII database which is isolated from the outside network and can only be accessed by private microservices of the service provider 100.

Once a buyer 102 has a verified ID 302 and verified financing 304 they may browse, view, or search configurations 412 of properties on configuration server 105. Property configurations may be created by sellers 104 or other parties acting for or on behalf of the sellers 104. Buyers 102 may access the configuration server 105 through webpages using computing devices. Buyers 102 may select locations, property parameters such as number of rooms, number of levels, size of rooms, etc., and options and upgrades that are available to them. A buyer 102 may access the configuration server 105 directly or through the service provider 100. While browsing or searching configurations, the service provider may also send a verified. ID 302, verified financing 304, or both the verified ID 302 and verified financing 304 to the configuration server 105 so that property information may be selected to display to a buyer 102 based on their financing limit, their browsing history, property criteria selected by the buyer 102, and other relevant information.

In embodiments, a verified ID is NOT required to browse and configure a property on the configuration server. In the case of resale homes, property information may be stored on a listing server like MLS/Realtors.com/Zillow, etc., rather than on the configuration server.

In embodiments a “verified badge” or other indication may be used as an indication that a buyer 102 has a verified ID 302. Once a buyer 102 completes the verified process, a verified badge, which may include a QR code, may be provided to buyers. The badge can be downloaded as a PDF file, or it can be added to a mobile wallet such as Apple Wallet or Google Wallet. A buyer can share the badge or invite a seller to view the badge. A scanner app on mobile devices may be used to allow sellers to scan the buyer's verified badge to obtain the buyer's basic information (i.e., name, email, phone, etc.) and verified status. The seller may request the verified and financial info of buyers through a secure permission based process granting the seller permission to view the buyer's verified info. The use of a verified badge may also be used for a rental home scenario in addition to the home buying.

A buyer 102 may also request bookings 414 to a self-tour provider 110 directly or through the service provider 100. Bookings may be used to schedule on-site tours of a property. The self-tour provider 110 may then forward a tour schedule to the seller 104 and confirm the tour with the buyer 102. When making a booking 414 or as part of the tour schedule 416, the service provider may also send a verified ID 302, verified financing 304, or both the verified ID 302 and verified financing 304 to the self-tour provider 110, the seller 104 to be able to confirm the identity of the buyer 102 for the tour.

In an embodiment, when a buyer 102 initiates a self-tour booking 414 request, the service provider 100 may post the reference ID of the verified 302 of the buyer 102 to an endpoint of the self-tour provider 110 to initiate the booking process. The self-tour provider 110 may then use the received reference ID, to request the verified ID of the buyer 102 through an API of the service provider 100 using the signed OAuth 2.0 bearer token. Upon receiving the request, the service provider 100 may use the signature key to authenticate the bearer token and return the signed and encrypted verified ID 302 data once it has been authenticated. The self-tour provider 110 may then then decrypt and normalize the verified ID 302 data that may also include verified financing data 304.

With reference to FIG. 4B, as part of an offer the buyer 102 may be required to make a deposit 418, which may be made through payment provider 112. The buyer 102 may make a request to the payment provider 112 directly or through service provider 100. The verified ID 302, verified financing 304, or both the verified ID 302, verified financing 304 may be sent to the payment provider to simply the process of the payment provider 112 in verifying the identity of buyer 102 and their available financial limit. Payment provider 112 may then provide the deposit to the seller 420. An offer 208 is sent directly from the buyer 102, or through the service provider 100, to the seller 104. The offer is associated with the verified ID 302 and the verified financing 304 of the buyer 102, attesting to the seller 104, the identity of the buyer 102 and proof of funds that the buyer 102 has sufficient financing to cover the amount offered. Offers 208 may also include other parameters such as closing dates, inspections, and other conditions. If the seller 104 accepts the offer, a purchase agreement, which may include a proof of deposit, is sent from the seller 104 to the service provider 100.

On closing 424, the service provider sends the verified ID 302 of the buyer 102, mortgage information included in the verified financing 304, and any other required information or instructions to the legal service 114. The legal service 114 may also send information such as the purchase agreement, statement of adjustment, drawings, survey, site plans, etc. to the legal service.

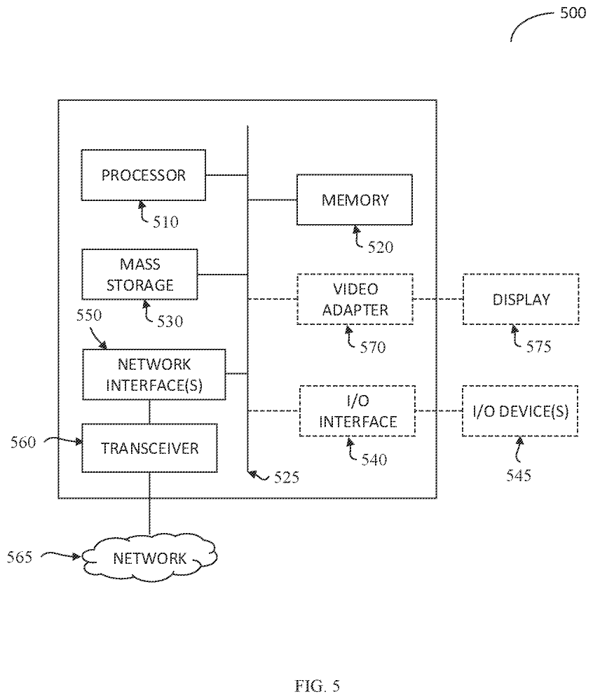

FIG. 5 is a schematic diagram of an electronic device 500 that may perform any or all of operations of the above methods and features explicitly or implicitly described herein, according to different embodiments of the present invention. For example, a mobile computing device, a physical or virtual computer or server may be configured as computing device 500.

As shown, the device includes a processor 510, such as a central processing unit (CPU) or specialized processors such as a graphics processing unit (GPU) or other such processor unit, memory 520, non-transitory mass storage 530, I/O interface 540, network interface 550, video adaptor 570, and any required transceivers 560, all of which are communicatively coupled via bi-bus 525. Video adapter 570 may be connected to one or more of display 575 and I/O interface 540 may be connected to one or more of I/O device 545 which may be used to implement a user interface. According to certain embodiments, any or all of the depicted elements may be utilized, or only a subset of the elements. Further, computing devices 500 may contain multiple instances of certain elements, such as multiple processors, memories, or transceivers. Also, elements of the hardware device may be directly coupled to other elements without the bus 525 Additionally, or alternatively to a processor and memory, other electronics, such as integrated circuits, may be employed for performing the required logical operations.

The memory 520 may include any type of non-transitory memory such as static random access memory (SRAM), dynamic random access memory (DRAM), synchronous DRAM (SDRAM), read-only memory (ROM), any combination of such, or the like. The mass storage element 530 may include any type of non-transitory storage device, such as a solid state drive, hard disk drive, a magnetic disk drive, an optical disk drive, USB drive, or any computer program product configured to store data and machine executable program code. According to certain embodiments, the memory 520 or mass storage 530 may have recorded thereon statements and instructions executable by the processor 510 for performing any of the aforementioned method operations described above.

It will be appreciated that it is within the scope of the technology to provide a computer program product or program element, or a program storage or memory device such as a magnetic or optical wire, tape or disc, USB stick, file, or the like, for storing signals readable by a machine, for controlling the operation of a computer according to the method of the technology and/or to structure some or all of its components in accordance with the system of the technology. Acts associated with the method described herein can be implemented as coded instructions in a computer program product. In other words, the computer program product is a computer-readable medium upon which software code is recorded to execute the method when the computer program product is loaded into memory and executed on the microprocessor of computing devices.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A method for facilitating a real estate transaction comprising:
sending an authentication request of a buyer to an identity authentication service;
receiving, from the authentication server, a verified identification (ID) of the buyer;
sending a financing request of the buyer to a financing server;
receiving, from the financing server, an approved limit of the verified ID;
sending an offer to a seller, the offer including the verified ID, the approved limit, and a property configuration of the buyer; and
receiving, from the seller, a response to the offer, the response based on the verified ID and the financing request.

2. The method of claim 2 wherein the property configuration is received from a server of the seller in response to the buyer selecting a plurality of preferences of a property described by the property configuration.

3. The method of claim 1 wherein the property configuration includes a location and a feature of the property.

4. The method of claim 1 wherein the approved limit includes one of:
a pre-approved mortgage limit,
proof of funds,
a deposit, or
an approved mortgage.

5. The method of claim 1 further comprising transferring a deposit from the buyer to the seller based on the verified ID and the approved limit.

6. The method of claim 1 wherein the response to the offer includes an acceptance of the offer, the method further comprising signing the offer, by the buyer and the seller, utilizing the verified ID and the approved limit.

7. The method of claim 6 further comprising transferring a purchase amount from the buyer to the seller based on the verified ID and the approved limit.

8. The method of claim 1 further comprising transferring an ownership of a property of the offer, the ownership being transferred to the buyer, the buyer being verified by the verified ID.

9. A method of purchasing a property comprising:
creating a profile of a user on a server of a service provider;
initiating with the service provider, an authentication request and uploading an identification document to the server to verifying an identity of the user, thereby creating a verified identification (ID) of the user, the verified ID being stored on the server;
initiating a financing request and obtaining an approved limit associated with the verified ID, the approved limit being stored on the server;
initiating with the service provider, an offer on the property, the offer including the verified ID, the approved limit, and a property configuration of the property; and
receiving from the service provider, a response to the offer.

10. The method of claim 9 wherein the property configuration is received from a server of a seller in response to the user selecting a plurality of preferences of a property described by the property configuration.

11. The method of claim 9 wherein the property configuration includes a location and a feature of the property.

12. The method of claim 9 wherein the approved limit includes one of:
a pre-approved mortgage limit,
proof of funds,
a deposit, or
an approved mortgage.

13. The method of claim 9 further comprising transferring a deposit from the user to the seller based on the verified ID and the approved limit.

14. The method of claim 9 wherein the response to the offer includes an acceptance of the offer, the method further comprising signing the offer, by the user and a seller, utilizing the verified ID and the approved limit.

15. The method of claim 14 further comprising transferring a purchase amount from the user to the seller based on the verified ED and the approved limit.

16. The method of claim 9 further comprising transferring an ownership of a property of the offer, the ownership being transferred to the user, the user being verified by the verified ID.

17. A method of selling a property comprising:
creating a profile of a property on a server of a service provider;
receiving from the service provider, an offer for the property, the offer including a verified identification (ID) of a buyer and an approved limit of the buyer;
generating a response to the offer based on the verified ID and the approved limit;
sending the response to the service provider;

18. The method of claim 17 wherein the profile includes one of:
a location of the property;
a configuration option of the property; or
a price of the property.

19. The method of claim 17 further comprising receiving a deposit of the buyer.

20. The method of claim 17 wherein the response to the offer includes an acceptance of the offer, the method further comprising signing the offer, by the buyer and a seller of the property, utilizing the verified ID and the approved limit.
